(19) United States
(12) Patent Application Publication
(10) Pub. No.: US 2008/0042573 A1
(43) Pub. Date: Feb. 21, 2008

(54) Plasma display panel

(75) Inventors: Hsu-Pin Kao, Pingjhen City (TW); Jang-Jeng Liang, Taoyuan City (TW); Sheng-Wen Hsu, Taipei City (TW); Hsu-Chia Kao, Pingjhen City (TW); Kai-Hsiang Hsu, Tucheng City (TW)

Correspondence Address: BIRCH STEWART KOLASCH & BIRCH, PO BOX 747, FALLS CHURCH, VA, 22040-0747, US

(73) Assignee: MARKETECH INTERNATIONAL CORP.

(21) Appl. No.: 11/889,770

(22) Filed: Aug. 16, 2007

(30) Foreign Application Priority Data
Aug. 18, 2006 (TW) 095130547

(51) Int. Cl. H01J 17/49

(52) U.S. Cl. 313/582

(57) ABSTRACT

A plasma display panel is provided. The plasma display panel includes a front plate, a back plate, a shadow mask, and a first adhesive layer. The shadow mask is located between the front plate and the back plate. The first adhesive layer is formed between the shadow mask and the front plate. The shadow mask is adhered to the front plate via the first adhesive layer. Thus, noises generated during plasma discharge processes in the plasma display panel can be reduced.

### BACKGROUND OF THE INVENTION

1. Field of the Invention

This present invention relates to a display apparatus and, more specifically, to a plasma display apparatus.

2. Description of the Prior Art

A plasma display panel (PDP) has many advantages such as high lightness, high efficiency, high contrast, high writing speed, and low cost. It is one of the current mainstream technologies of large-sized digital flat display panel.

As shown in FIG. 1, a conventional plasma display panel 10 includes three main parts: a front plate 12, a back plate 14, and a shadow mask 16 between the front plate 12 and a back plate 14.

In general, the front plate 12 includes a first glass substrate 121, a plurality of transparent electrodes 122, a plurality of auxiliary electrodes 123, a transparent dielectric layer 124, and a first protective layer 125. The back plate 14 includes a second glass substrate 141, a plurality of address electrodes 142, a dielectric layer 143, and a second protective layer 144. The shadow mask 16 includes a plurality of barrier ribs 161 and a plurality of color phosphors 162. In this example, the marks 162A, 162B, and 162C represent red, green, and blue phosphors respectively.

Each of the independent spaces including the color phosphors 162 among the barrier ribs 161 can be seen as one luminous cell. These luminous cells are filled with a mixture of noble gases such as He, Ne, Xe, etc. The transparent electrode 122 in the front plate 12 and the address electrode 142 in the back plate 14 can cooperate to generate high voltage electricity. In this way, the gases in all luminous cells will be triggered to discharge and radiate ultraviolet rays. The ultraviolet rays will excite these color phosphors 162 to generate visible lights of red, green and blue. By controlling the transparent electrode 122 in the front plate 12 and the address electrode 142 in the back plate 14, the control circuit (not shown in the figure) of the plasma display panel 10 can decide whether the luminous cells radiate and what their radiation strength is. The beams radiated by these luminous cells can further constitute images including various colors.

In practical applications, these transparent electrodes 122 are usually conductible ITO or SnO₂ plated on the first glass substrate 121. The effect of the auxiliary electrodes 123 is to lower the resistance of the transparent electrodes 122. The transparent dielectric layer 124 and the dielectric layer 143 are also called the dielectric layers. They can store charges and achieve memory effect to keep the images. The material of the first protective layer 125 and the second protective layer 144 is usually MgO; its function is to prevent the wearing out of the electrodes.

In the prior art, the front plate 12, the back plate 14, and the shadow mask 16 are not adhered to each other; they are fixed by the stress generated from a pressure difference between inside and outside. However, especially in the manufacturing process of large-sized panels, it is not easy to produce completely smooth surfaces of the front plate 12, the back plate 14, and the shadow mask 16. That is to say, in actual applications, the front plate 12, the back plate 14, and the shadow mask 16 can not stick close to each other. As those skilled in the art know, the gases in luminous cells will vibrate during the discharge process. This vibration will make the shadow mask 16 also vibrate and produce unpleasant noises.

### SUMMARY OF THE INVENTION

In order to solve the above problems, the invention provides a method to reduce the noises. According to the invention, a preferred embodiment is a plasma display panel including a front plate, a back plate, a shadow mask, and a first adhesive layer. The shadow mask is located between the front plate and the back plate. The first adhesive layer is formed between the shadow mask and the front plate. The shadow mask is adhered to the front plate via the first adhesive layer. In this way, noises generated by the plasma display panel during plasma discharge processes can be reduced.

The advantage and spirit of the invention may be understood by the following recitations together with the appended drawings.

### BRIEF DESCRIPTION OF THE APPENDED DRAWINGS

FIG. 1 shows the structure of a conventional plasma display panel (PDP).

FIG. 2A, FIG. 2B, and FIG. 2C show the structure of the plasma display panel according to a preferred embodiment of the invention.

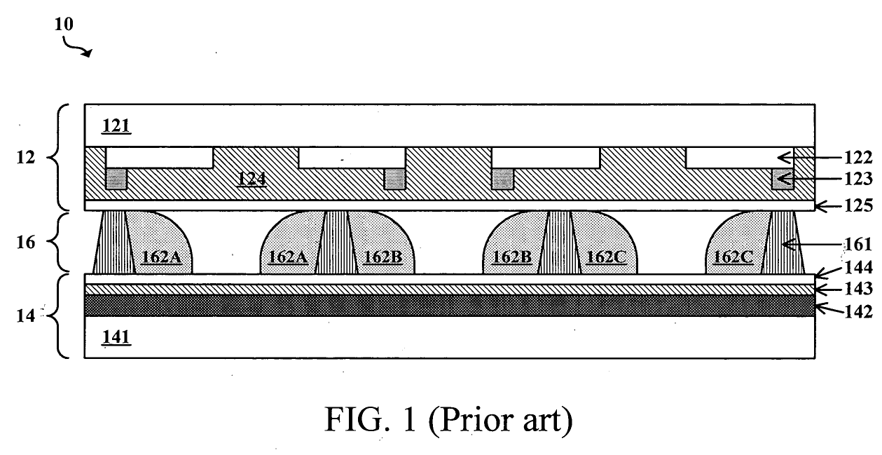

### DETAILED DESCRIPTION OF THE INVENTION

A plasma display panel with reduced noises is provided in the invention.

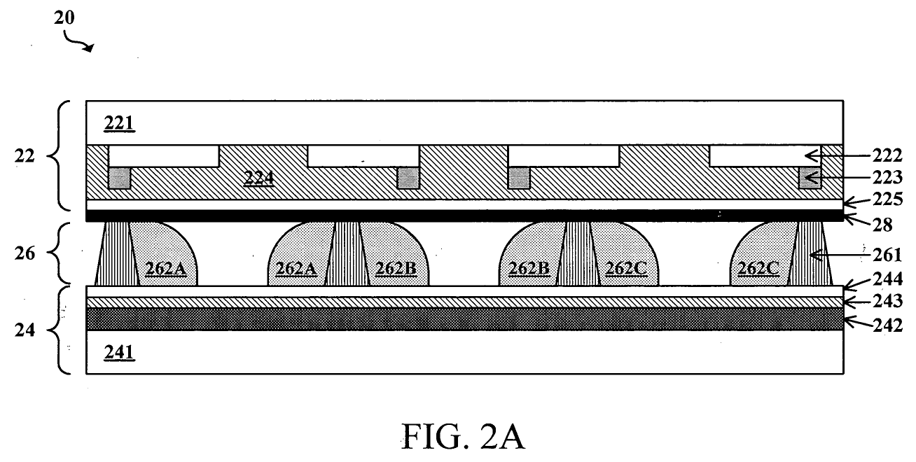

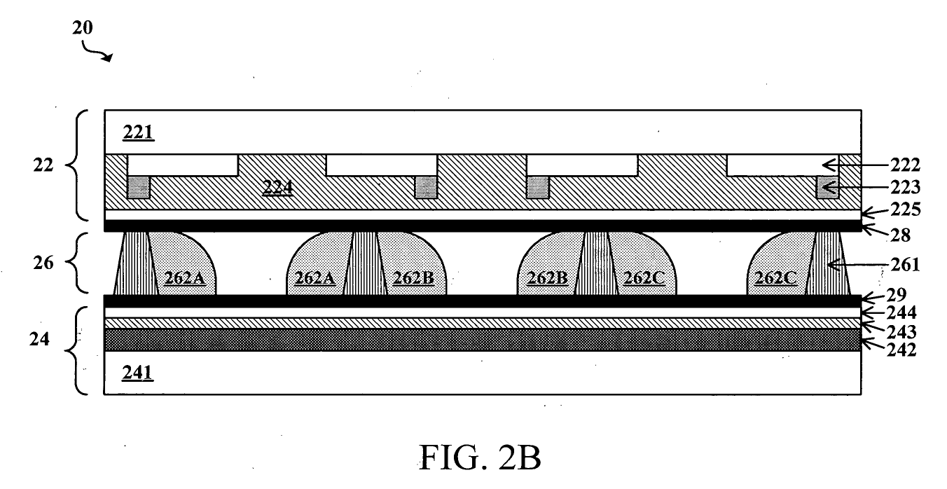

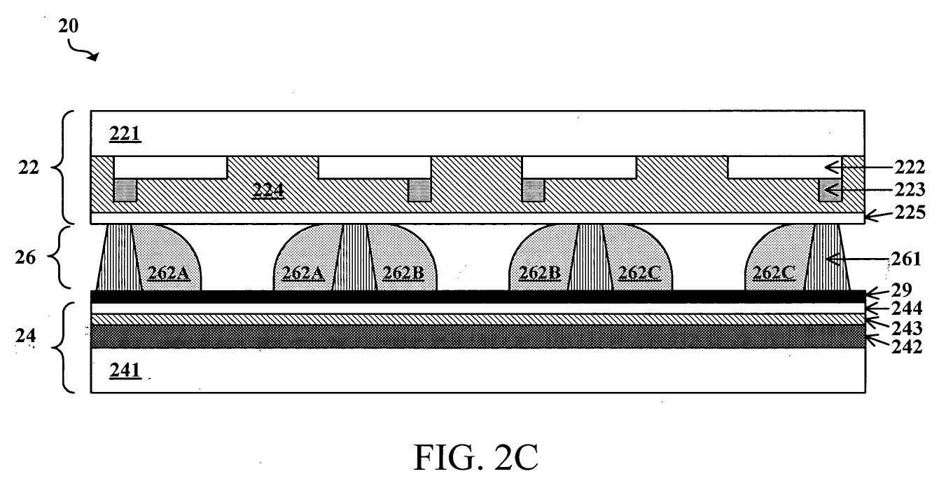

According to the invention, a preferred embodiment is a plasma display panel. Referring to FIG. 2A, FIG. 2A is a schematic diagram of the preferred embodiment. The plasma display panel 20 includes a front plate 22, a back plate 24, a shadow mask 26, and a first adhesive layer 28. The shadow mask 26 is located between the front plate 22 and the back plate 24. The first adhesive layer 28 is formed between the shadow mask 26 and the front plate 22.

In this embodiment, the front plate 22 includes a first glass substrate 221, a plurality of transparent electrodes 222, a plurality of auxiliary electrodes 223, a transparent dielectric layer 224, and a first protective layer 225. The back plate 24 includes a second glass substrate 241, a plurality of address electrodes 242, a dielectric layer 243, and a second protective layer 244. The shadow mask 26 includes a plurality of barrier ribs 261 and a plurality of color phosphors 262. The red, green, and blue phosphors are respectively represented by the marks 262A, 262B, and 262C. As those skilled in the art know, the devices included by the above mentioned front plate 22, back plate 24, and shadow mask 26 may have some differences in various plasma display panels. Thus, the devices of the front plate 22, back plate 24 and shadow mask 26, according to the invention, are not necessarily the same as those shown in FIG. 2A.

In practical applications, the first adhesive layer 28 may include glass or other similar material and is used to stick the shadow mask 26 to the front plate 22. Taking glass as an example, the producer can first spread glass powder or glass liquid on the plane of the shadow mask 26 opposite to the front plate 22 during the process of manufacturing plasma display panel 20. Afterward, the step of sealing and air-extracting will be done. When the temperature rises beyond the melting temperature of the glass material during the process, the glass powder or glass liquid spread on the shadow mask 26 will be melted, thus making the shadow mask 26 and the front plate 22 stick together. When the temperature decreases below the melting point of the glass material, the glass powder or glass liquid will be solidified to form the first adhesive layer 28 shown in FIG. 2A. The shadow mask 26 is accordingly adhered to the front plate 22 via the first adhesive layer 28. Besides, the melting temperature of the first adhesive layer 28 is lower than the melting temperature of the sealing glue used to fix the layers in the plasma display panel 20. In this way, the shadow mask 26 and the front plate 22 can stick together more firmly.

According to the invention, the plasma display panel 20 can further include a second adhesive layer 29 formed between the shadow mask 26 and back plate 24 to fix the shadow mask 26 to the back plate 24, as shown in FIG. 2B. Besides, the plasma display panel 20 can also include the second adhesive layer 29 without the first adhesive layer 28.

In order to improve contrast performance in a bright room, low-reflectivity material such as black glass can be used as the material applied between the shadow mask 26 and the front plate 22. It can reduce the reflection of light from the environment.

In the embodiment according to the invention, when the gas discharges, the shadow mask 26 can not generate vibration alone because it is solidified with the front plate 22 or the back plate 24. Therefore, the problems of noise in the prior art can be resolved.

With the above example and explanation, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A plasma display panel (PDP), comprising:
a front plate;
a back plate;
a shadow mask located between the front plate and the back plate; and
a first adhesive layer formed between the shadow mask and the front plate.

2. The PDP of claim 1, wherein the front plate comprises a first glass substrate, a transparent electrode, an auxiliary electrode, a transparent dielectric layer, and a first protective layer.

3. The PDP of claim 2, wherein the material of the transparent electrode comprises indium tin oxide (ITO) or SnO₂.

4. The PDP of claim 1, wherein the back plate comprises a second glass substrate, an address electrode, a dielectric layer, and a second protective layer.

5. The PDP of claim 1, wherein the shadow mask comprises a plurality of barrier ribs and a plurality of color phosphors.

6. The PDP of claim 1, wherein the material of the first adhesive layer comprises glass; during the process of forming the first adhesive layer, the glass is heated, melted, and solidified; the shadow mask is accordingly adhered to the front plate via the first adhesive layer.

7. The PDP of claim 1, wherein the melting temperature of the first adhesive layer is lower than or equal to the melting temperature of the sealing glue used to fix the front plate, the back plate, and the shadow mask.

8. The PDP of claim 1, the PDP further comprising:
a second adhesive layer formed between the shadow mask and the back plate.

9. The PDP of claim 8, wherein the material of the second adhesive layer comprises glass; during the process of forming the second adhesive layer, the glass is heated, melted, and solidified; the shadow mask is accordingly adhered to the back plate via the second adhesive layer.

10. A plasma display panel (PDP), comprising:
a front plate;
a back plate;
a shadow mask located between the front plate and the back plate; and
a second adhesive layer formed between the shadow mask and the back plate.
